(19) United States
(12) Patent Application Publication
(10) Pub. No.: US 2016/0328040 A1
(43) Pub. Date: Nov. 10, 2016

(54) TOUCH PANEL AND APPLICATIONS THEREOF

(71) Applicant: Innolux Corporation, Chu-Nan (TW)

(72) Inventors: Chen-Ting HUANG, Chu-Nan (TW); Chieh-Yen LEE, Chu-Nan (TW); Min-Che TSAI, Chu-Nan (TW); Chen-Chou HSU, Chu-Nan (TW); Te-Yu LEE, Chu-Nan (TW)

(73) Assignee: Innolux Corporation, Chu-Nan (TW)

(21) Appl. No.: 15/148,547

(22) Filed: May 6, 2016

(30) Foreign Application Priority Data
May 8, 2015 (TW) 104114696

(51) Int. Cl. G06F 3/041

(52) U.S. Cl. CPC G06F 3/041; G06F 2203/04103

(57) ABSTRACT

A touch panel including a first substrate and a sensing electrode is provided. The sensing electrode includes a first metal layer, a metal second metal layer, a metal nitride layer, and a metal oxide layer. The first metal layer is disposed on the first substrate and includes a first metallic element. The second metal layer includes a second metallic element. The metal nitride layer includes the second metallic element and is disposed on the second metal layer. The metal oxide layer is disposed on the metal nitride layer.

This application claims the benefit of Taiwan application Serial No. 104114696 filed May 8, 2015, the present disclosure of which is incorporated by reference herein in its entirety.

### TECHNICAL FIELD

The present disclosure relates in general to a touch panel and applications thereof, and more particularly a touch panel with multilayer sensing electrode and applications thereof.

### BACKGROUND

A conductive film structure has an optical characteristic of being permeable to the light, and can be used as a touch sensor layer of a touch panel. Traditionally, a metal material, such as aluminum, copper or other suitable metal or an alloy thereof, deposited on a substrate by a deposition process, such as physical vapor deposition (PVD), may be further patterned to form a layer of metal electrodes serving as the touch sensor layer of the touch panel.

However, since the metal material used for forming the touch sensor layer still can reflect the incident light, thus the touch sensor layer can be easily detected by the user's eyes, and the display quality of the display apparatus applying the touch panel may be conversely affected. To resolve the above problem, a multilayer film structure with optical design has been provided. According to a process for forming the multilayer film structure, a metal sputtering process is performed in a vacuum chamber, by which a metal target is bombarded with a plasma containing nitrogen (N₂) to form a metal nitride film which is conductive and permeable to the light and can be realized by an aluminum nitride film, covering on a layer of metal film electrodes, and a metal oxide layer, is then disposed on the metal nitride film serving as an anti-reflection layer to reduce the amount of incident light reflected from the surface of the metal film electrode.

However, because the target used for forming the metal nitride film may easily react with nitrogen, thus nitride residues is likely accumulated on the surface of the target during the sputtering process. As the number of processing batch increases, the sheet resistance of the subsequently formed metal nitride film may be increased accordingly, and the transparency of the metal nitride film may be also increased, so as to reduce its anti-reflection effect and severely affect the display quality of the display apparatus.

Therefore, it has become a prominent task for the industries to provide an advanced conductive film structure and applications and a manufacturing method thereof to resolve the problems encountered in the prior art.

### SUMMARY

According to one aspect of the present disclosure, a touch panel is provided. The touch panel includes a first substrate and a sensing electrode. The sensing electrode includes a first metal layer, a second metal layer, a metal nitride layer, and a metal oxide layer. The first metal layer is disposed on the first substrate. The second metal layer is disposed on the first metal layer. The metal nitride layer is disposed on the second metal layer. The metal oxide layer is disposed on the metal nitride layer.

According to another aspect of the present disclosure, a touch display apparatus is provided. The display apparatus includes a first substrate, a second substrate, a display medium and a sensing electrode. The display medium is disposed between the first substrate and the second substrate. The sensing electrode includes a first metal layer, a second metal layer, a metal nitride layer, and a metal oxide layer. The first metal layer is disposed on the first substrate. The second metal layer is disposed on the first metal layer. The metal nitride layer is disposed on the second metal layer. The metal oxide layer is disposed on the metal nitride layer.

As disclosed above, a touch panel and a touch display apparatus using the same are provided in the embodiments of the present disclosure. A metal nitride layer and a metal oxide layer are formed on the metal electrode layer (the first and second metal layers) of the sensing electrode of the display apparatus by way of deposition. The metal oxide layer has a refractive index substantially smaller than that of the metal nitride layer, and is used as an anti-reflection layer of the display apparatus to restrict incident light coming from the external environment from being reflected by the metal electrode layer. In the manufacturing process, through adjusting nitrogen content in the reactive gas atmosphere, a sputtering process can be performed in a nitrogen-free atmosphere to form a second metal layer between the first metal layer and the metal nitride layer, wherein the second metal layer contains the same material as the metal nitride layer but has much lower content of nitrogen atoms than the metal nitride layer.

Since the nitrogen atoms can be cleaned by the sputtering process for forming the second metal layer, thus nitrogen atoms resulted from the process for forming the metal nitride film may not be accumulated on the surface of the target. After a number of consecutive sputtering processes, the content of nitrogen atoms in the metal nitride layer may not increase too much, hence the sheet resistance of the metal nitride layer may not be increased, the transparency of the metal nitride layer may not be affected, and the anti-reflection effect of the touch panel can be reduced. As a result, the display quality of the display apparatus may be improved.

### BRIEF DESCRIPTION OF THE DRAWINGS

The above and other aspects of the present disclosure will become better understood with regard to the following detailed description of the preferred but non-limiting embodiment(s). The following description is made with reference to the accompanying drawings.

FIGS. 1A to 1E are cross-sectional views illustrating series of the processing structures for forming a sensing electrode according to an embodiment of the present disclosure;

FIG. 2 is a cross-sectional view illustrating a partial processing structure for forming a sensing electrode according to another embodiment of the present disclosure;

FIG. 3A is a curve chart illustrating the sheet resistance of metal nitride layers measured in various batch processes;

FIG. 3B is a curve chart illustrating the sheet resistance of metal nitride layers measured in various batch processes between which a blank sheet sputtering step is inserted; and

FIG. 4 is a cross-sectional view illustrating a display apparatus using the sensing electrode depicted in FIG. 1E.

### DETAILED DESCRIPTION

The present disclosure provides a conductive film structure used in a touch display apparatus, its applications and a manufacturing method thereof capable of restricting incident light coming from the external environment reflected therefrom and improving the display quality of the touch display apparatus. A number of preferred embodiments with accompanying drawings are disclosed below to make the embodiments, objects, technical features and advantages of the invention clearly understood.

It should be noted that these specific methods and implementations are not for limiting the scope of protection of the invention. The invention can be implemented by using other features, elements, methods and parameters. The preferred embodiments are merely for illustrating the technical features of the invention, not for limiting the scope of protection of the invention. Anyone skilled in the technology field will be able to make suitable modifications or changes based on the specification disclosed below without breaching the spirit of the invention. The identical elements of the embodiments are designated with the same reference numerals.

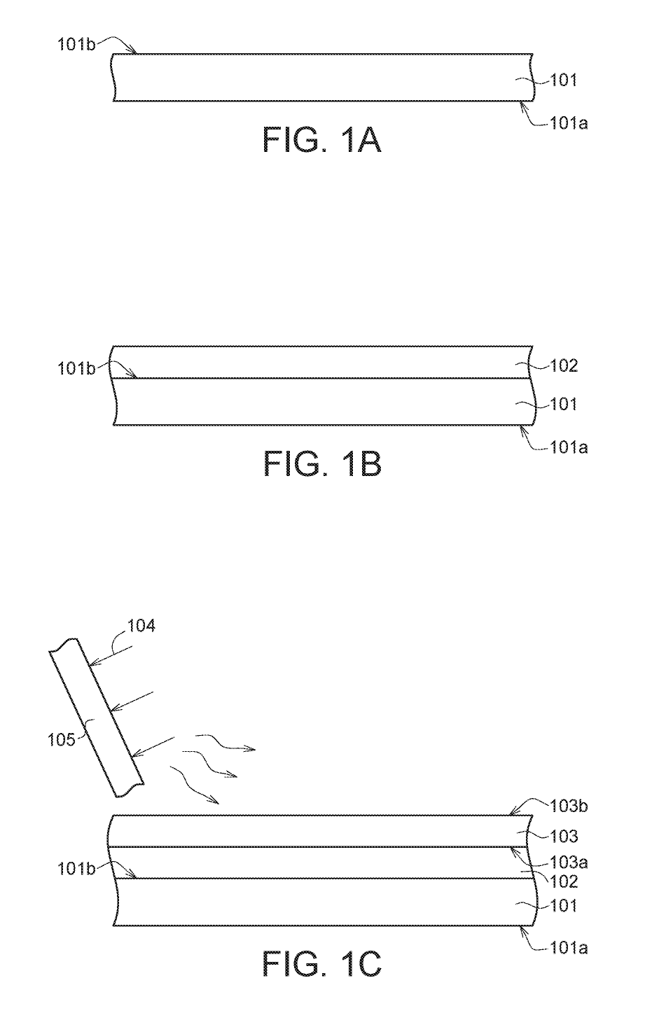

FIGS. 1A to 1E are cross-sectional views illustrating series of the processing structures for forming a sensing electrode 100 according to an embodiment of the present disclosure. The method for forming the sensing electrode 100 includes following steps: Firstly, a substrate 101 is provided (as shown in FIG. 1A). In an embodiment of the present disclosure, the substrate 101 can be a light-permeable substrate for a LCD, OLED, or LED display panel. For example, within the LCD display panel, the color filter layer is formed on the bottom surface 101a of the light-permeable substrate (substrate 101) closer to a liquid crystal layer of the display panel. In the present embodiment, the sensing electrode 100 is formed on the top surface 101b of the light-permeable substrate (substrate 101) departing away from the liquid crystal layer. For convenience of description, detailed structure of the display panel is disclosed below. In other embodiments, such as OLED, LED display panel, the substrate 101 is an opposite substrate with respect to a thin film transistor substrate.

Then, a first metal layer 102 is formed on the top surface 101b of the substrate 101 (see FIG. 1B). In an embodiment of the present disclosure, the first metal layer 102 can be realized by a conductive film formed on the top surface 101b of the substrate 101 by deposition process, such as sputtering, physical vapor deposition (PVD), chemical vapor deposition (CVD), or other applicable method. The first metal layer is made of a material selected from a group consisting of gold (Au), silver (Ag), titanium (Ti), tungsten (W), indium (In), zinc (Zn), aluminum (Al), neodymium (Nd), copper (Cu), and arbitrary combinations thereof. The thickness of the first metal layer 102 is substantially between 2000 angstroms (Å) to 3000 Å. In the present embodiment, the first metal layer 102 is preferably an aluminum-neodymium (Al—Nd) alloy layer whose thickness is about 2600 Å.

Then, a second metal layer 103 is formed on the first metal layer 102, and has a first surface 103a and a second surface 103b opposite to the first surface 103a, wherein the first surface 103a is disposed adjacent to the first metal layer 102 (see FIG. 1C), and the second metal layer 103 is preferably made of aluminum. In some embodiments of the present disclosure, the method for forming the second metal layer 103 includes a sputtering process performed in a nitrogen-free reaction atmosphere, in which a metal target 105 is bombarded with a plasma 104 formed of high energy argon or other inert gases, so as to form the second metal layer 103 on the first metal layer 102.

In some embodiments of the present disclosure, the metal target 105 preferably can be realized by an aluminum alloy (Al—X), which further includes a third metallic element X selected from a group consisting of neodymium (Nd), copper (Cu), gold (Au), silver (Ag), titanium (Ti), tungsten (W), indium (In), zinc (Zn), and any combination thereof. In the present embodiment, the metal target 105 includes an aluminum-copper alloy, and the second metal layer 103 formed by the sputtering process can be an aluminum copper (Al—Cu) alloy layer whose thickness is substantially between 200 Å to 300 Å and preferably is about 240 Å. In the present embodiment, the first surface 103a of the second metal layer 103 is in contact with the first metal layer 102. In other embodiments, a conductive layer (not illustrated) can be formed between the first surface 103a of the second metal layer 103 and the first metal layer 102. The total thickness of the first metal layer 102 and the second metal layer 103 is substantially between 2000 Å to 3500 Å.

Then, the same metal target 105 is used to form a metal nitride layer 106 on the second surface 103b of the second metal layer 103, and to make the metal nitride layer 106 in contact with the second surface 103b of the second metal layer 103 (as shown in FIG. 1D). The metal nitride layer 106 is made of an alloy nitride. In some embodiments of the present disclosure, the method for forming the metal nitride layer 106 includes a sputtering process performed in a reaction atmosphere containing nitrogen (N₂), in which the metal target 105 is bombarded with a plasma 107 formed of high energy argon or other inert gases, so as to form aluminum alloy nitride (Al—X—N) layer on the second surface 103b of the second metal layer 103.

In some embodiments of the present disclosure, the said aluminum alloy nitride layer (metal nitride layer 106) formed by the sputtering process may include aluminum-copper alloy nitride (Al—Cu—N). The thickness of the metal nitride layer 106 is substantially between 500 Å to 600 Å and preferably is about 560 Å. In the present embodiment, the metal nitride layer 106 has a third surface 106a and a fourth surface 106b opposite to the third surface 106a. The third surface 106a of the metal nitride layer 106 is in contact with the second surface 103b of the second metal layer 103. In other embodiments, a transparent conductive layer not containing nitrogen can be formed between the third surface 106a of the metal nitride layer 106 and the second surface 103b of the second metal layer 103.

In the manufacturing process for forming the metal nitride layer 106, nitrogen (N₂) is used in the sputtering process, and a small amount of nitrogen atoms may be accumulated on the surface of the metal target 105. During the batch process, that is, in the consecutive sputtering process for alternately forming the second metal layer and the metal nitride layer, although the second metal layer is sputtered in a nitrogen-free reaction atmosphere, a small amount of nitrogen atoms previously accumulated on the surface of the metal target 105 may be bombarded and evicted therefrom, and the region of the second metal layer 103 near the first surface 103a may still contain some nitrogen with very low atomic percent (at %). In the present embodiment, the atomic percent of nitrogen contained in the second metal layer 103 is substantially between 0 at % to 1 at %.

Next, a metal oxide layer 108 is formed on the fourth surface 106b of the metal nitride layer 106. The metal oxide layer 108 comprises indium, zinc, indium, gallium, tin or other suitable metallic element, and is in contact with the fourth surface 106b of the metal nitride layer 106. The metal oxide layer 108 has a refractive index substantially smaller than that of the metal nitride layer 106. Meanwhile, the sensing electrode 100 as shown in FIG. 1E is accomplished.

In some embodiments of the present disclosure, the metal oxide layer 108 can be formed by, for example a sputtering process, a physical vapor deposition, a chemical vapor deposition or other applicable method. The thickness of the metal oxide layer 108 is substantially between 400 Å to 500 Å. The metal oxide layer 108 may include transparent conductive oxide, such as indium zinc oxide (IZO), or indium tin oxide (ITO) or even at the same time include indium tin oxide and indium zinc oxide. In the present embodiment, the metal oxide layer 108 is preferably realized by an IZO layer whose thickness is about 420 Å.

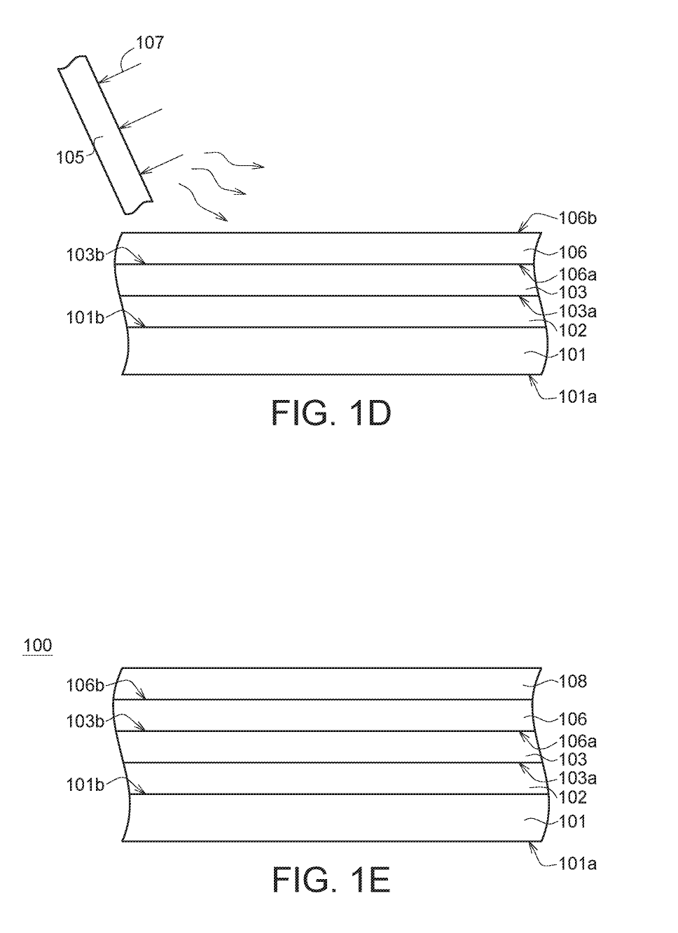

FIG. 2 is a cross-sectional view illustrating a partial processing structure for forming a sensing electrode 200 according to another embodiment of the present disclosure. The process for forming the sensing electrode 200 is similar to that for forming the sensing electrode 100 except that the process for forming the sensing electrode 200 omits the step for forming the first metal layer 102 as indicated in FIG. 1B. Instead, a thicker second metal layer 203 is directly formed on the top surface 101b of the substrate 101 (as indicated in FIG. 2). In other words, the first metal layer 102 and the second metal layer 203 are made of the same kind of material. Therefore, the first metal layer 102 and the second metal layer 203 as a whole is regarded as a thicker second metal layer 203. Subsequent manufacturing process of the film conductive structure 200 is identical to that of the sensing electrode structure 100, and the similarities are not redundantly described here.

In the present embodiment, the structure of the sensing electrode 200 is similar to that of the sensing electrode 100 of FIG. 1E except that the sensing electrode 100 of FIG. 1E is a four-layer structure including the first metal layer 102 but the sensing electrode 200 of FIG. 2 is a three-layer structure without involving the first metal layer 102. The thickness of the second metal layer 203 is substantially between 2000 Å to 3500 Å and preferably is about 3000 Å. Similarly, in the manufacturing process for forming the metal nitride layer 106, nitrogen is used in the sputtering process, and a small amount of nitrogen atoms may be accumulated on the surface of the metal target 105. During the batch process, that is, in the consecutive sputtering process for alternately forming the second metal layer and the metal nitride layer, although the second metal layer is formed by the sputtering process performed in a nitrogen-free reaction atmosphere, a small amount of nitrogen atoms previously accumulated on the surface of the metal target 105 may be bombarded and evicted therefrom, and the region of the second metal layer 203 near the top surface 101b of the substrate 101 may still contain some nitrogen with very low atomic percent (at %). In the present embodiment, the atomic percent of nitrogen contained in the second metal layer 203 is substantially between 0 at % to 1 at %.

According to the above disclosure, since the second metal layer 103 or 203 is formed by the sputtering process in a nitrogen-free reaction atmosphere, thus the nitrogen atoms previously accumulated on the surface of the metal target 105 during the sputtering process of the metal nitride layer 106 can be bombarded and evicted therefrom, so as to avoiding nitrogen atoms from being continually accumulated on the surface of the metal target 105 and transported into the metal nitride layer 106. As the result, the sheet resistance of the metal nitride layer 106 may not be increased, the refractive index of the metal nitride layer 106 may not be changed and the anti-reflection effect of the metal nitride layer 106 and the metal oxide layer 108 may not be conversely affected.

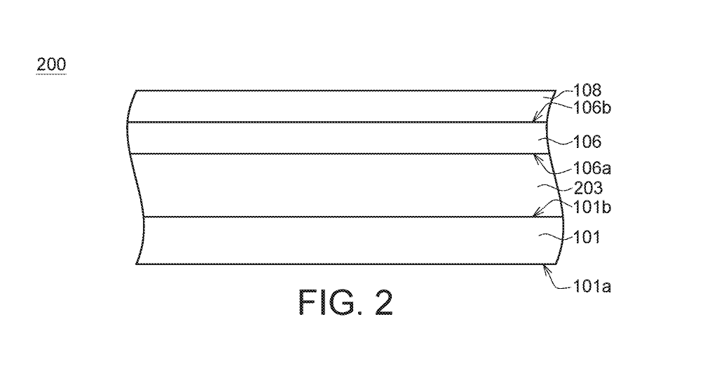

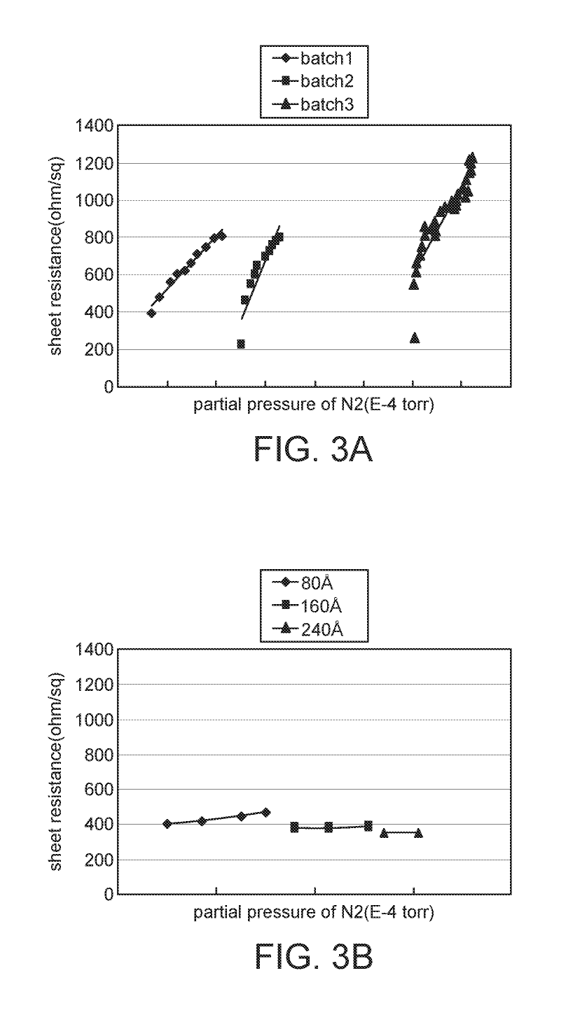

Refer to FIG. 3A and FIG. 3B. FIG. 3A is a curve chart illustrating the sheet resistance of metal nitride layers measured in various batch processes. FIG. 3B is a curve chart illustrating the sheet resistance of metal nitride layers measured in various batch processes between which a blank sheet sputtering step is performed in a nitrogen-free reaction atmosphere. In other words, a blank sheet sputtering step is inserted between two consecutive nitrogen-containing sputtering processes. During the blank sheet sputtering step, a sacrificial metal layer is formed on a blank substrate. In FIG. 3A, each dot represents the sheet resistance of a metal nitride layer formed under a predetermined partial pressure of N₂ in a particular consecutive sputtering process. Multiple adjacent dots represent the sheet resistances of various metal nitride layer subjected by the same consecutive sputtering processes. The plurality of dots can be connected to form a curve indicating the change of sheet resistance in the batch process. In FIG. 3A, the curves designated by diamonds, squares and triangles respectively represent the change of sheet resistance of the metal nitride layer provided by different comparison examples during different batch processes. In FIG. 3B, the curves designated by diamonds, squares and triangles represent the sheet resistance of the metal nitride layer during different batch processes in which the thickness of the sacrificial metal layers are equivalent to 80 Å, 160 Å and 240 Å, respectively.

The horizontal axis represents a partial pressure of N₂ during the sputtering process for forming a metal nitride layer. The vertical axis represents a sheet resistance (ohm/sq) obtained by measuring a metal nitride layer. As indicated in FIG. 3A, the sheet resistance of the metal nitride layer measured in consecutive sputtering processes of the batch process shows a rising trend. The sheet resistance surges from 400 ohm/sq to 800 ohm/sq or even 1200 ohm/sq. In FIG. 3B, since a blank sheet sputtering step is inserted between two consecutive sputtering processes, the sheet resistance of the metal nitride layer does not rise over consecutive sputtering processes of the batch process but steadily remains at around 400 ohm/sq instead. Since nitrogen atoms accumulated on the surface of the metal target over consecutive sputtering processes will be bombarded and evicted during the inserted blank sheet sputtering step, the sheet resistance of the metal nitride layer does not rise over the consecutive sputtering processes of the batch process.

FIG. 3A and FIG. 3B indicate that the second metal layers 103 and 203 provided in the embodiments of the present disclosure, to a certain degree, may serve as the sacrificial metal layer disclosed above. During the sputtering process forming the second metal layers 103 and 203, the nitrogen atoms accumulated on the surface of the metal target 105 can be bombarded and evicted therefrom, so as to avoiding nitrogen atoms from being continually accumulated on the surface of the metal target 10 and transported into the metal nitride layer 106. As the result, the sheet resistance of the metal nitride layer 106 may not be increased, and the transparency of the metal nitride layer 106 may not be changed.

Subsequently, series of downstream processes, such as patterning, wiring, assembling and bonding process are performed, meanwhile a touch panel 12 with a sensing electrode 100 (or 200) is formed. The present disclosure, the touch panel 12 can further be integrated with a backlight module 13 and a display panel 11 to form a display apparatus 10 with touch sensing function. In some embodiments of the present disclosure, the touch panel 12 can be realized by a capacitive touch panel. The sensing electrode 100 can be patterned to form a plurality of sensing electrodes of the capacitive touch panel 12.

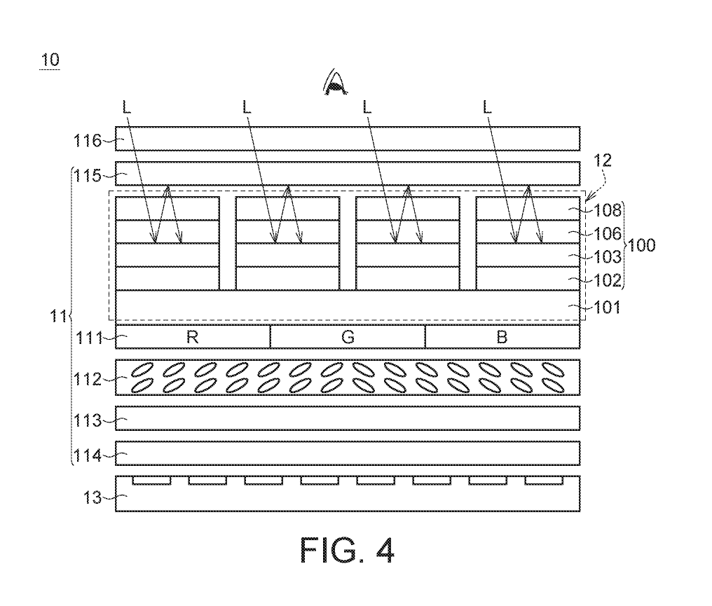

FIG. 4 is a cross-sectional view illustrating a display apparatus 10 using the sensing electrode 100 depicted in FIG. 1E. In the present embodiment, the display apparatus 10 has a backlight module 13, a display panel 11 and a cover glass 116. The backlight module 13 is disposed adjacent to the display panel 11. The cover glass 116 is disposed on one side of the display panel 11 opposite to the backlight module 13.

In detail, the display panel 11 at least includes a substrate 101, a color filter layer 111, a display medium (such as a liquid crystal layer 112), a thin-film transistor (TFT) substrate 113, a bottom polarizer 114 and a top polarizer 115. The backlight module 13 is disposed adjacent to the bottom polarizer 114 of the display panel 11. The sensing electrode 100 is disposed between the color filter layer 111 and the top polarizer 115.

When incident light L coming from the external environment, passes through the cover glass 116 and the top polarizer 115 and reaches the sensing electrode 100, it can be reflected by the first metal layer 102 and the second metal layer 103. Since the metal oxide layer 108 having a refractive index smaller than that of the metal nitride layer 106 can be used for shielding the incident light L reflected from the first metal layer 102 and the second metal layer 103, thus the sensing electrode 100 applying the same can serve as a black metal to make the incident light L hardly being perceived by the user to detect. As a result, the display quality of the display apparatus 10 can be improved.

As disclosed above, a touch panel and a touch display apparatus using the same are provided in the embodiments of the present disclosure. A metal nitride layer and a metal oxide layer contacting the metal nitride layer are formed on the metal electrode layer (the first metal layer) of the sensing electrode of the display apparatus by way of deposition. The metal oxide layer has a refractive index substantially smaller than that of the metal nitride layer, and is used as an anti-reflection layer of the display apparatus to restrict incident light coming from the external environment from being reflected by the metal electrode layer. In the manufacturing process, through adjusting nitrogen content in the reactive gas atmosphere, a sputtering process can be performed in a nitrogen-free atmosphere to form a second metal layer between the first metal layer and the metal nitride layer, wherein the second metal layer contains substantially the same material as the metal nitride layer but has much lower content of nitrogen atoms than the metal nitride layer.

Since the nitrogen atoms can be cleaned by the sputtering process for forming the second metal layer, thus nitrogen atoms resulted from the process for forming the metal nitride film may not be accumulated on the surface of the target. After a number of consecutive sputtering processes, the content of nitrogen atoms in the metal nitride layer may not increase too much, hence the sheet resistance of the metal nitride layer may not be increased, the transparency of the metal nitride layer may not be affected, and the anti-reflection effect of the touch panel can be reduced. As a result, the display quality of the display apparatus may be improved.

It will be apparent to those skilled in the art that various modifications and variations can be made to the disclosed embodiments. It is intended that the specification and examples be considered as exemplary only, with a true scope of the present disclosure being indicated by the following claims and their equivalents.

What is claimed is:

1. A touch panel, comprising:
a first substrate;
a sensing electrode disposed on the first substrate, comprising:
a first metal layer;
a second metal layer disposed on the first metal layer;
a metal nitride layer disposed on the second metal layer; and
a metal oxide layer disposed on the metal nitride layer.

2. The touch panel according to claim 1, wherein the first metal layer has a thickness substantially ranging from 2000 angstroms (Å) to 3000 Å.

3. The touch panel according to claim 1, wherein the second metal layer has a thickness substantially ranging from 200 Å to 300 Å.

4. The touch panel according to claim 1, wherein the metal nitride layer has a thickness substantially ranging from 500 Å to 600 Å.

5. The touch panel according to claim 1, wherein the metal oxide layer has a thickness substantially ranging from 400 Å to 500 Å.

6. The touch panel according to claim 1, wherein the first metal layer is made of a material selected from a group consisting of gold (Au), silver (Ag), titanium (Ti), tungsten (W), indium (In), zinc (Zn), aluminum (Al), neodymium (Nd), copper (Cu), and arbitrary combinations thereof.

7. The touch panel according to claim 6, wherein the first metal layer is made of an aluminum-neodymium alloy.

8. The touch panel according to claim 1, wherein the second metal layer is made of a material selected from a group consisting of gold (Au), silver (Ag), titanium (Ti), tungsten (W), indium (In), zinc (Zn), aluminum (Al), neodymium (Nd), copper (Cu), and arbitrary combinations thereof.

9. The touch panel according to claim 8, wherein the second metal layer is made of an alloy.

10. The touch panel according to claim 9, wherein the metal nitride layer is made of an alloy nitride.

11. The touch panel according to claim 8, wherein the second metal layer is made of an aluminum-copper alloy.

12. The touch panel according to claim 11, wherein the metal nitride layer is made of an aluminum-copper alloy nitride.

13. The touch panel according to claim 1, wherein the metal oxide layer has a refractive index substantially smaller than that of the metal nitride layer.

14. The touch panel according to claim 1, wherein the first metal layer and the second metal layer are made of the same kind of material.

15. The touch panel according to claim 14, wherein the first metal layer and the second metal layer have a total thickness substantially ranging from 2000 Å to 3500 Å.

16. A touch display apparatus, comprising:
a first substrate;
a second substrate;
a display medium disposed between the first substrate and the second substrate;
a sensing electrode disposed on the first substrate, comprising:
a first metal layer;
a second metal layer disposed on the first metal layer;
a metal nitride layer disposed on the second metal layer; and
a metal oxide layer disposed on the metal nitride layer.
